(19) United States
(12) Patent Application Publication
(10) Pub. No.: US 2015/0221185 A1
(43) Pub. Date: Aug. 6, 2015

(54) GAMING DEVICE AND METHOD FOR MULTI-HAND VIDEO POKER

(71) Applicants: Vlad Dunaevsky, Toronto (CA); Serge Bourenkov, Toronto (CA)

(72) Inventors: Vlad Dunaevsky, Toronto (CA); Serge Bourenkov, Toronto (CA)

(73) Assignee: RATIONAL INTELLECTUAL HOLDINGS LIMITED, Onchan (IM)

(21) Appl. No.: 14/304,114

(22) Filed: Jun. 13, 2014

Related U.S. Application Data
(60) Provisional application No. 61/934,326, filed on Jan. 31, 2014.

(51) Int. Cl. G07F 17/32

(52) U.S. Cl. CPC G07F 17/3293; G07F 17/3211; G07F 17/3244; G07F 17/3209; G07F 17/3262

(57) ABSTRACT

Embodiments of the present invention comprise a poker gaming system in which a user can select a number of user hands and a number of dealer hands to play against. Cards are dealt to both the user and the dealer. The user may place an initial bet based on his hand(s) and the likelihood that his hand(s) are better than each of the dealer's hands. The player may also have the option to place side bets in which the user may receive bonuses based on his hand(s). After the user places his bets, the dealer's hands are revealed. The user's hand(s) are compared to each of the dealer's hands, and payouts are determined.

### RELATED APPLICATIONS

This application claims priority to U.S. Patent Application Ser. No. 61/934,326 filed on Jan. 31, 2014, the content of which is incorporated herein in its entirety.

### BACKGROUND

The present invention relates to a gaming device, system, and method for multi-hand video poker.

The popularity of video and online poker has grown significantly in recent years. Users are now able to play poker in a wide variety of settings, ranging from their homes to traditional casino floors. Gaming companies and casinos have developed various permutations of video and online poker games to spark continuing interest from poker enthusiasts and newcomers alike. In conventional poker games, users played against each other. The game has evolved to include variations in which the user (or player) plays against a dealer (or the house), thus eliminating the need for additional poker players (which may or may not be available to play at a time desired by the user). For example, in “Three Card Poker,” a player is dealt three cards and competes against a dealer's three-card hand. The player's hand is compared to the dealer's hand and a winner is determined based on the rules of the game.

Additionally, as more users play from home on their personal device(s), poker gaming has become a more fast-paced, high stakes game. In traditional multi-hand poker games, a user can choose to play several hands of poker at the same time against a single dealer hand. The user has the option to discard cards and receive new cards for each of his/her hands. The player places a unique wager for each of his hands and wins/loses based on how his/her hand fares in comparison to the dealer's single hand. Although this type of poker is more fast-paced than traditional, single-hand poker, it is still time consuming because replacement cards must be dealt. Moreover, players do not feel like they are truly playing multiple hands of poker at the same time, because each of their hands are being compared to a single dealer hand.

### BRIEF DESCRIPTION OF THE DRAWINGS

FIG. 1 is a block diagram of a multi-hand video poker system according to an embodiment of the present invention

FIG. 2 is a block diagram of a gaming suite and a gaming database according to an embodiment of the present invention.

FIG. 3 is a flowchart of the gameplay process for a multi-hand video poker game according to an embodiment of the present invention.

FIGS. 4(a)-(c) are examples of user interfaces (“UIs”) for a poker game according to an embodiment of the present invention.

FIG. 5 is an example of a UI for a poker game according to an embodiment of the present invention.

FIG. 6(a) and (b) are examples of UIs for a poker game according to an embodiment of the present invention.

FIG. 7 is an example of a UI for a poker game according to an embodiment of the present invention.

FIG. 8 is diagram illustrating how pay-outs may be determined for each hand of a multi-hand poker game according to an embodiment of the present invention.

FIG. 9 illustrates a UI for the system according to an embodiment of the present invention.

FIG. 10 is an example of a UI for a poker game according to an embodiment of the present invention.

FIG. 11 is diagram illustrating how pay-outs may be determined for each hand of a multi-hand poker game according to an embodiment of the present invention.

FIGS. 12(a) and (b) are diagrams illustrating payout rules according to an embodiment of the present invention.

FIGS. 13(a) and (b) are diagrams illustrating payout rules according to an embodiment of the present invention.

FIG. 14 illustrates a gaming device according to an embodiment of the present invention.

FIG. 15 illustrates a set of gaming device according to an embodiment of the present invention.

FIG. 16 illustrates an electronic gaming table device according to an embodiment of the present invention.

FIGS. 17(a)-(d) are exemplary pay-out tables for the various types of bets made in a multi-hand poker game according to an embodiment of the present invention.

### DETAILED DESCRIPTION

Embodiments of the present invention comprise a poker gaming system in which a user can select a number of user hands and a number of dealer hands to play against. Cards are dealt to both the user and the dealer. The user may place an initial bet based on his hand(s) and the likelihood that his hand(s) are better than each of the dealer's hands. The player may also have the option to place side bets in which the user may receive bonuses based on his hand(s). After the user places his bets, the dealer's hands are revealed. The user's hand(s) are compared to each of the dealer's hands, and payouts are determined.

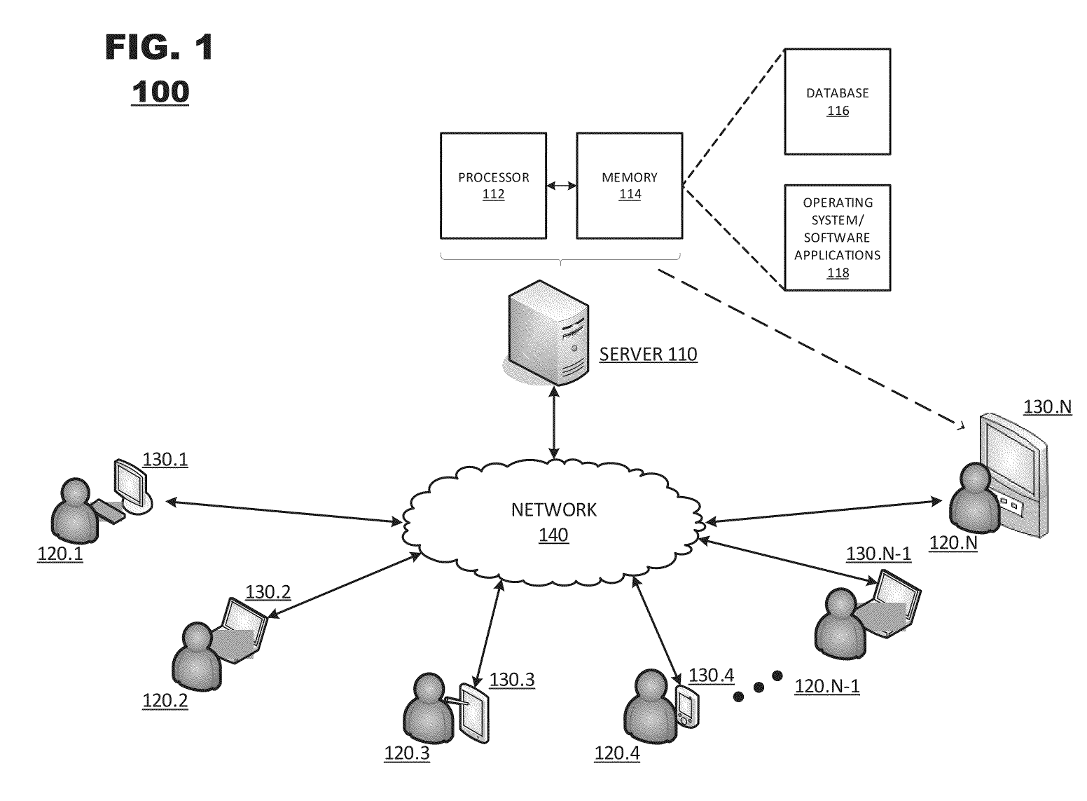

FIG. 1 is a block diagram of a multi-hand video poker system 100 according to an embodiment of the present invention. The system 100 may include a server 110, a network 140, and a plurality of users (or players) 120.1-120.N and associated devices 130.1-130.N.

The network 140 may include any number of local area networks (LANs), wireless local area networks (WLANs), wide area networks (WANs), mobile communication networks, and the Internet to facilitate communication between the server 110 and the user devices 130.1-130.N.

The devices 130.1-130.N may include, but are not limited to, desktop computers (130.1 for example), laptop computers (130.2 for example), tablets (130.3 for example), smart phones (130.4 for example), video game terminals (130.N for example), and other devices that may be capable of accessing a website or application over the network 140 to allow the users 120.1-120.N to participate in a video poker games hosted by the server 110. For example, a given user (120.1 or 120.2) may operate a desktop (130.1) or laptop computer (130.2) to navigate to the video poker website by using a web browser. Some users (120.3 or 120.4) may download and access a mobile application to access the video poker content on their mobile tablet (130.3) or smart phone (130.4).

The sever 110 may include various sub-components such as a processor 112 and a memory 114. The processor 112 may be provided in various configurations, such as a central processing unit (“CPU”), a field-programmable gate array (“FPGA”), an application specific integrated circuit (“ASIC”), or any other suitable logic device or combination of logic devices. The processor 112 may execute video poker programs and access/modify data associated with such programs as described below.

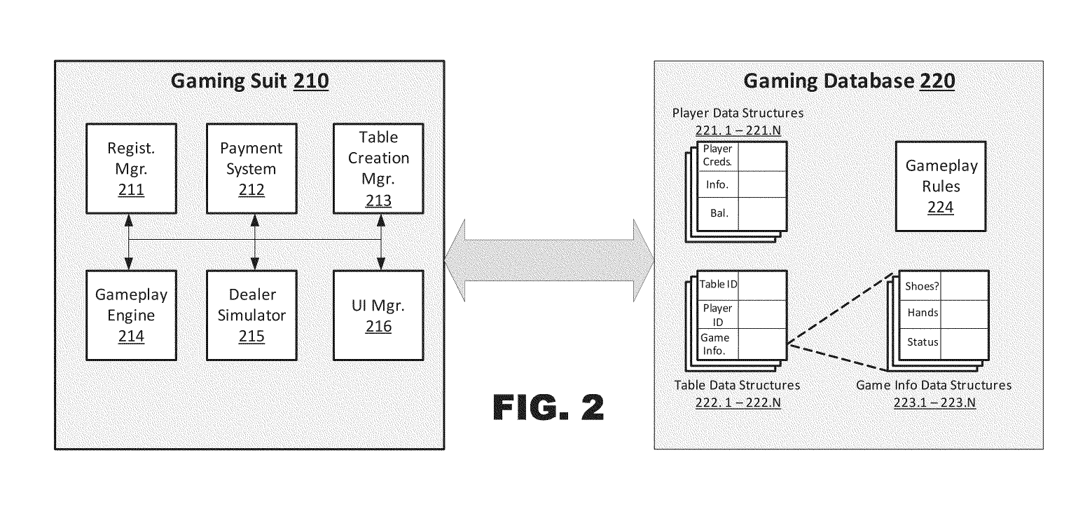

The memory 114 may include a machine readable medium which may include volatile memory (such as DRAM, SRAM, or the like) and non-volatile memory (such as ROM, RLASH, EEPROM, or the like). The memory 114 may store processor-executable instructions 118 (i.e., software programs such as operating system software and other software applications that may be used to run the video poker website or application) and a database 116 which may be modified and/or accessed by the processor 112. The software applications 118 may include a suite of gaming programs (or software applications) (described in further detail below with respect to FIG. 2) that may be used to run the video poker website and/or application. There may be other types of software applications stored in the memory as desired by the server administrators. The database 116 may be a hierarchical database that may include linked data structures (described in more detail with respect to FIG. 2) that store information. The information may include player information, game rules, game information, etc.

The server 110 and the devices 130.1-130.N may include communication interfaces to enable them communicate with each other over the network 140. As described in more detail below, the server 110 may host video poker games that may be accessed by the devices 130.1-130.N to allow players to play video poker games according to an embodiment of the present invention.

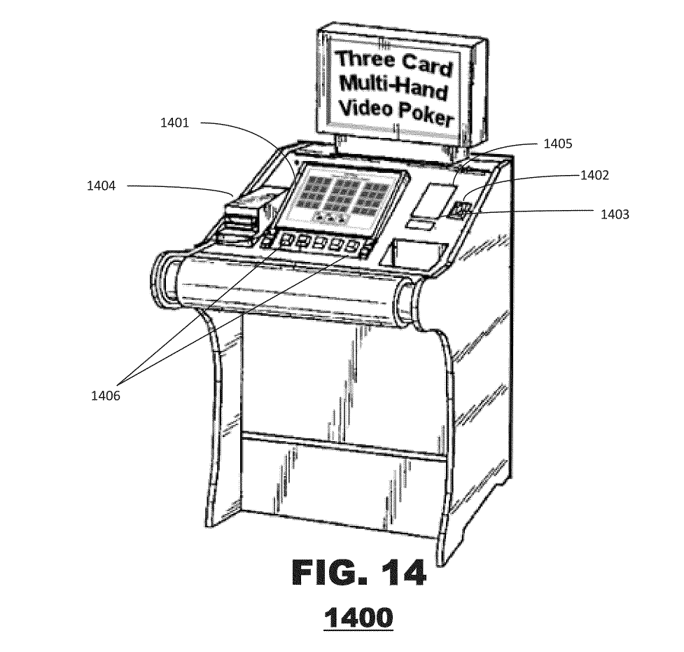

According to an embodiment of the present invention, the video game terminal 130.N (or any of the other devices 130.1-130.N−1 discussed above) may include an internal processor 112 and memory 114 and may locally host a video poker game. In such an embodiment, the video game terminal 130.N may not need to connect to the server 110 to allow a user to play video poker. Instead, the memory 114 of the terminal 130.N may include the database 116 and the operating system/software applications 118 described above. Such a device 130.N may be located in a live casino floor as a video terminal or kiosk, a hotel operating on a local network, cruise ships, and airplanes for on-flight gaming networks, for example. FIGS. 14-16 are examples of such video gaming terminals.

FIG. 2 is a block diagram of a gaming suite 210 and a gaming database 220, which may be stored in the memory 114 of the gaming system 100 of FIG. 1. The gaming database 220 may include a plurality of player data structures 221.1-221.N, a plurality of virtual poker table data structures 222.1-222.N, and a game rules data structure 224.

The player data structures 221.1-221.N may store information relating to each player (or user) that is registered to play video poker on a website or application hosted by the server 110. The player data may include: a player ID, log in credentials, preferences, payment information, current balance, etc.

The table data structures 222.1-222.N may store information relating to each active table on a website or application hosted by the server 110. The table data may include: a table ID, a player ID associated with the table, and corresponding game information 223.1-223.N. The game information data structures 223.1-223.N may include, for each corresponding table 222.1-222.N, the number of virtual shoes active on the table, the player's hand, the dealers hand, the game status, etc. The player data structures 221.1-221.N and the table data structures 222.1-222.N may be linked and may share common information.

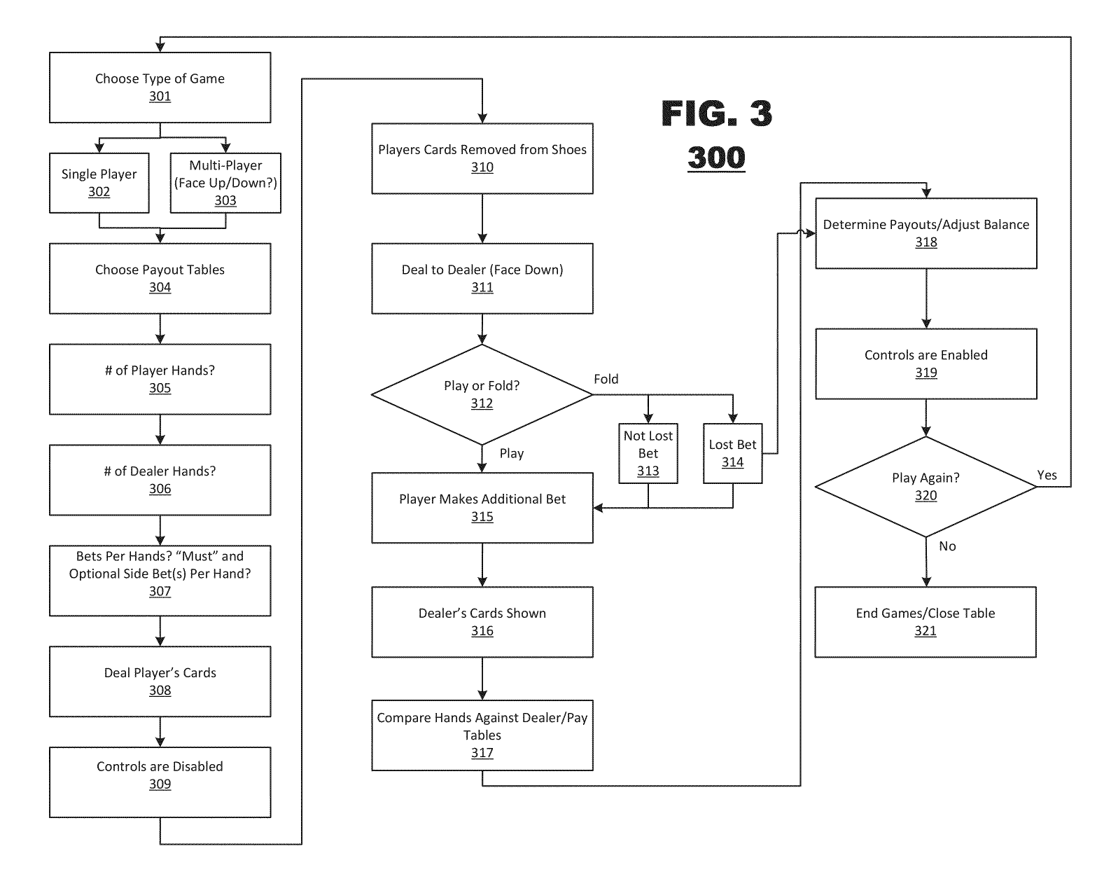

The game rules data structure 224 may include the rules of various poker games, including multi-hand video poker (described below with respect to FIGS. 3-13). The rules data structure 224 may also include statistics data associated with the various poker games and payout rules.

The gaming suite 210 may include a plurality of programs (or software applications) that may be stored in the memory 114 and executed by the processor 112 of FIG. 1. The programs may work together to operate the video poker games described below with respect to FIGS. 3-10. The programs may include at least a registration manager 211, a payment system 212, a table creation manager 213, a gameplay engine 214, a dealer simulator 215, and a user interface (“UI”) manager 216.

The registration manager 211 may control the registration process for the video poker website (or application) hosted on the server 110 of FIG. 1. Users may interact with the registration manager 211 to sign up for a video poker account. The registration manager 211 may access and modify data stored in the player data structures 221.1-221.N.

The payment system 212 may control the payment processing for the video poker players. Users may be able to add money to their account or cash out their balance using the payment system 212. The payment system 212 may access and modify the player data structures 221.1-221.N, the table data structures 222.1-222.N, and the game information data structure 223.1-223.N associated with each unique table data structure 222.1-222.N.

The table creation manager 213 may create new table entries in the table data structures 222.1-222.N in response to a player's request to start a new game. The table creation manager 213 may access and modify the player data structures 221.1-221.N, the table data structures 222.1-222.N, and the game information data structures 223.1-223.N associated with each unique table data structure 222.1-222.N.

The gameplay engine 214 may control the gameplay aspects of the video poker website (or application) as described in more detail below with respect to FIG. 3-13. The gameplay engine 214 may access and modify data stored in the table data structures 222.1-222.N, the game information data structures 223.1-223.N associated with each unique table data structure 222.1-222.N, and the gameplay rules data structure 224.

The dealer simulator 215 may control the dealing, shuffling, and other features of each poker game table in response to a player's actions. The dealer simulator 215 may access and modify the table data structures 222.1-222.N, the game information data structures 223.1-223.N, and the gameplay rules data structure 224.

The UI manager 216 may control the visual design of the video poker website or application hosted on the server 110 of FIG. 1 and how the website or application interacts with users. For example, the UI manager 216 may determine where certain UI elements, such as logos, scroll bars, buttons, etc, are located on the website and/or application. The UI preferences may be selected by a system administrator.

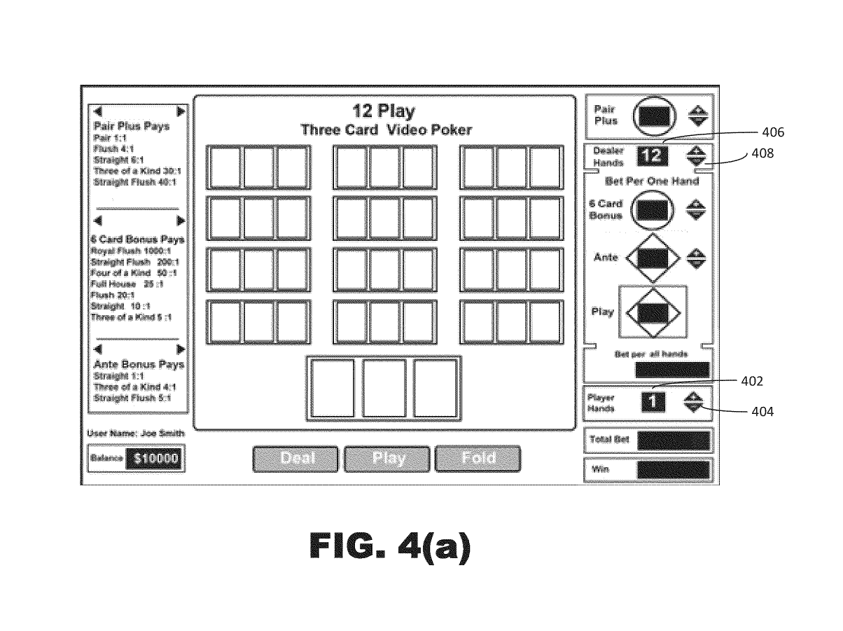

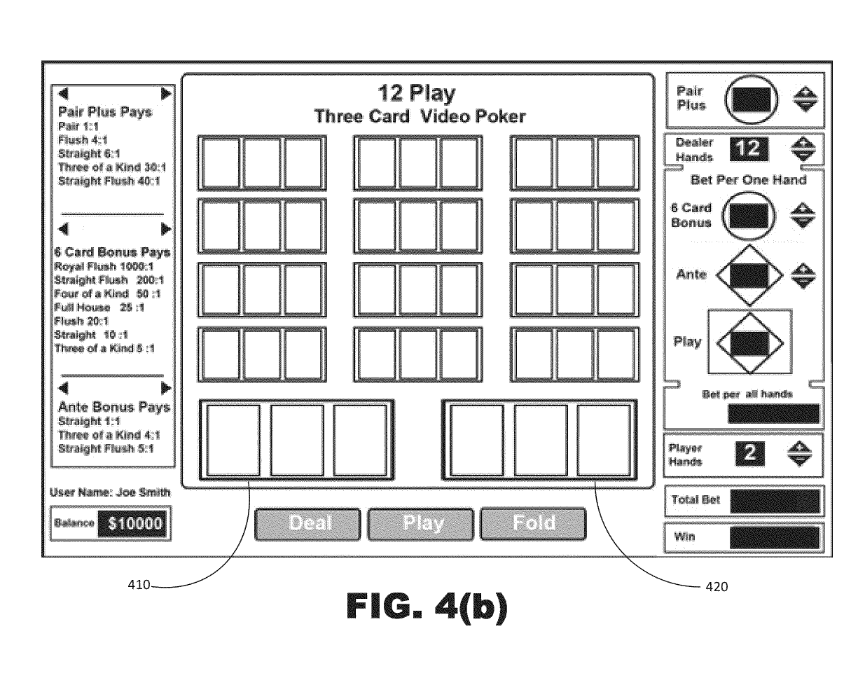

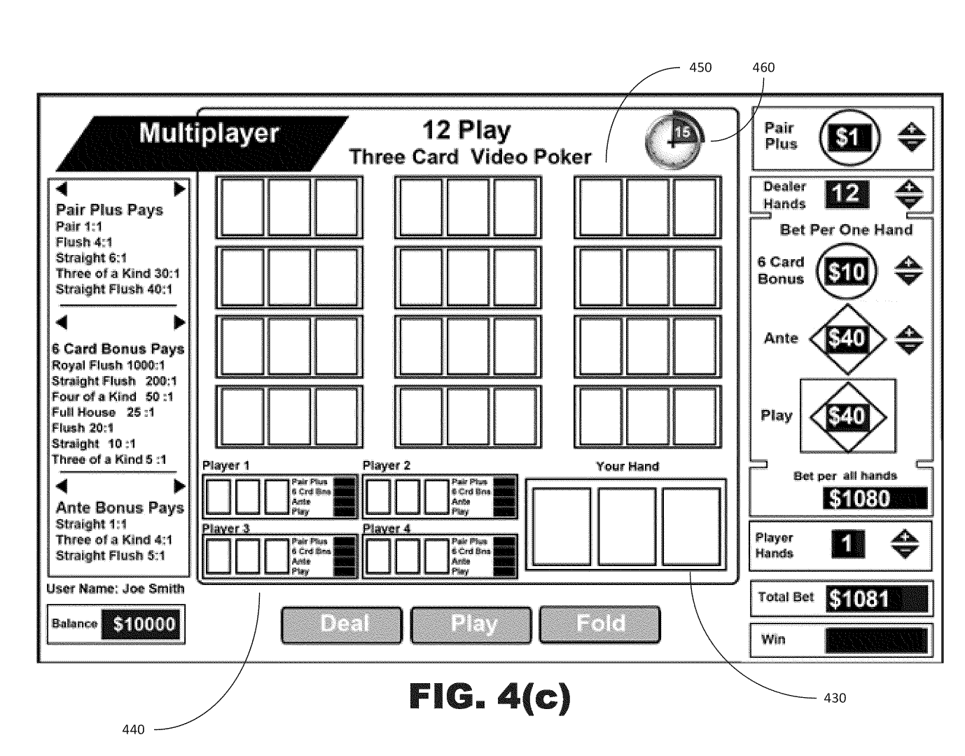

FIG. 3 is a flowchart 300 of the gameplay process for a multi-hand video poker game according to an embodiment of the present invention. FIGS. 4-8 are screenshots of exemplary user interfaces (UIs) of a multi-hand video poker game generated by the UI manager 216 of FIG. 2 according to an embodiment of the present invention. The screenshots in FIGS. 4-8 may correlate to the process described in the flowchart 300 illustrated in FIG. 3 as described hereinbelow. Moreover, elements in the gaming suite 210 and gaming database 220 of FIG. 2 described above may be referenced in the description of FIGS. 3-8 below.

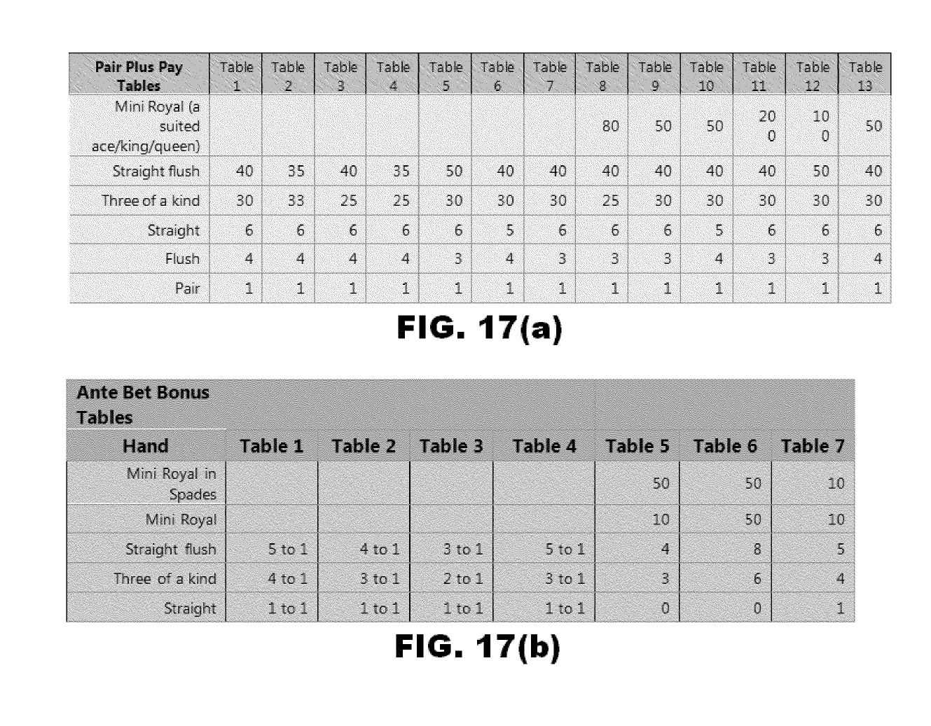

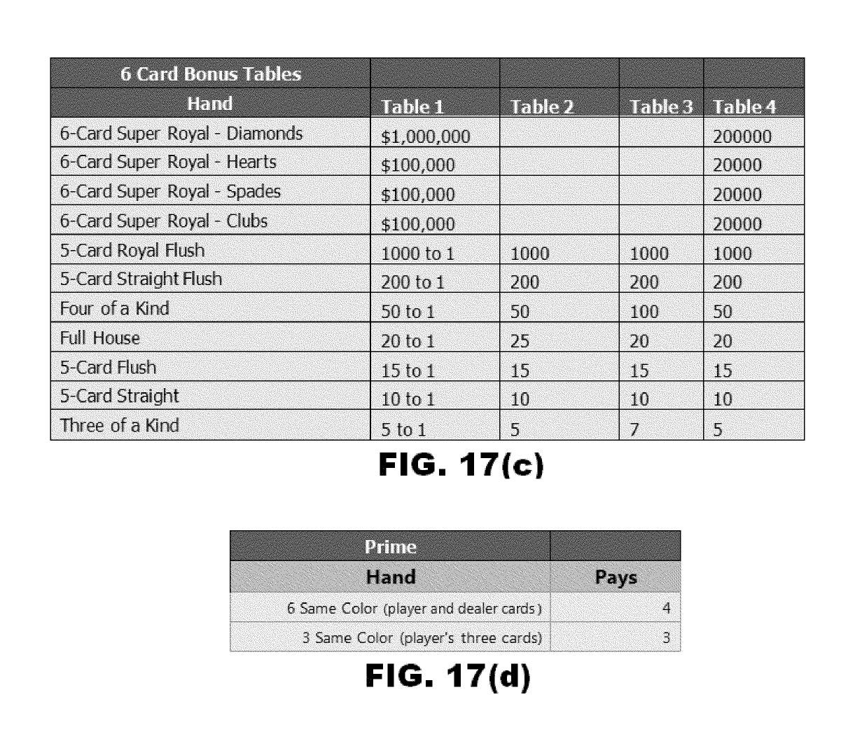

Once a player decides to play the multi-hand video poker game, the table creation manager 213 may create a unique table data structure, 222.N for example, which may store information for the current game session as described above with respect to FIG. 2. The UI manager 216 may subsequently launch a user interface to allow the player to play multi-hand video poker. At step 301, once the UI manager 216 launches the poker game user interface, the player may select which type of game he/she wants to play. For example, the player may select a single player game (step 302) or a multi-player game (step 303). If the player selects a multi-player game, he/she may have an option to choose whether to keep his/her cards face up (“Public View”) or face down (“Private View”) during play (described in further detail below with respect to FIG. 4(c)). Once the player chooses the type of game, he/she may select a payout table (e.g., the payout tables in FIGS. 17(a)-(d) described below) at step 304. Next, the player may choose the number of hands he/she would like to play (step 305) and the number of dealer hands he/she would like to play against (step 306). The player's selections in steps 301-306 may be stored in the corresponding table data structure 222.N.

FIG. 4(a) is an example of a single player, single hand UI for a poker game according to an embodiment of the present invention. The UI may include a “player hands” field 402 and a “dealer hands” field 406. The UI may also include corresponding (+/−) controls 404 (for the player hands field 402) and 408 (for the dealer hands field 406). A player may directly enter a number into the fields 402 and 406 (e.g., using a keyboard) or use the (+/−) controls 404 and 408 to increase or decrease the number of player or dealer hands (e.g., using a mouse). In this example, the user may select one player hand to play against twelve dealer hands. A corresponding number (twelve) of “virtual shoes” with one deck of cards each may be created and stored in the table data structure 222.N as described above with respect to FIG. 2.

FIG. 4(b) is an example of a single player, multi-hand UI for a poker game according to an embodiment of the present invention. The UI may be similar to the UI shown in FIG. 4(a), however in this case, the user may select “2” player hands instead of “1.” As shown in FIG. 4(b), the UI may display a first player hand 410 and a second player hand 420.

FIG. 4(c) is an example of a multi-player, single-hand UI for a poker game according to an embodiment of the present invention. The UI may be similar to the UIs shown in FIGS. 4(a) and (b) above, however in this case, the user may choose to play against other players and the dealer. As shown in FIG. 4(c), the UI may display the player's hand 430, other players' hands 440, and the dealer hands 450. To enhance game security in multi-players games, a player may select a “Public View” or “Private View” option. In the Public View option, the player's hand and his/her competitors' hands may be shown (face up) when they are dealt. In the Private View option, the players' hands as well as his/her competitors' hands may be kept faced down until a play/fold action is selected. The UI may optionally include a timer 460 in the multi-player mode which may govern the time limit to place initial bets for each player and the time limit to make a decision to play or fold for each player. For the Private View option, the player's hand and his/her competitors' hands may be revealed automatically when the timer expires. A player may have an option to pick the time limit for a given game. For example, there may be “Play-Fast” tables with 30 second timers or “Play-Slow” tables with 60 second timers. There may be other set options for time limits or the player may set his/her own custom time limit if desired.

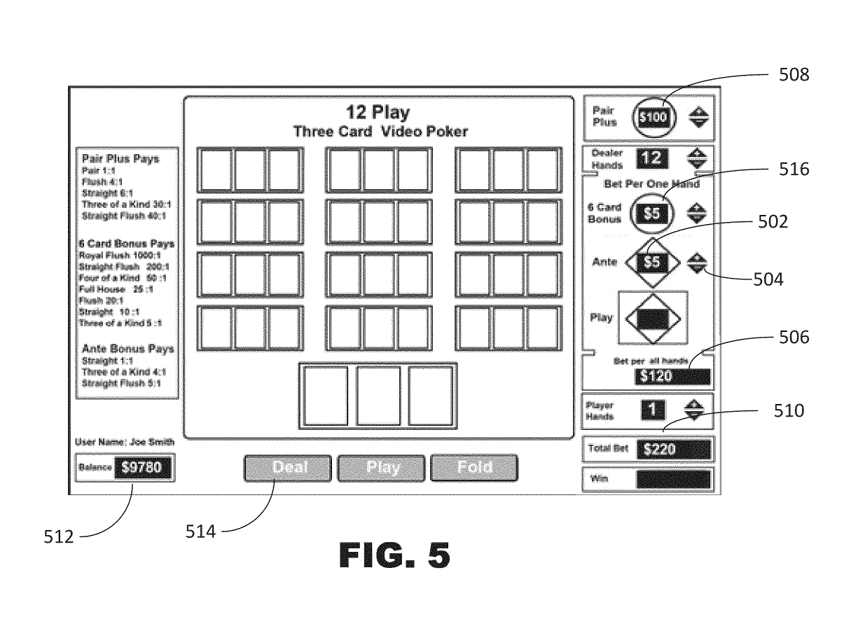

At step 307, the player may place his/her initial bet per hand. The initial bet may include mandatory bets (e.g., ante bets) and optional side bet (e.g., Prime bets). The initial bet may include an ante-multi-play bet, a side-bet, and a pair plus single bet. The ante multi-play bet results may be based on a comparison between the player's hand(s) and the dealers hands. The side bet may include one or more side bets such as a “6 (or less) Card Bonus bet,” a “Prime bet,” or another similar side bet. The side bet payout result may be based on a combination of the player's hand and each of the dealer's hands against the pay tables (shown in FIGS. 17(a)-(d)). The pair plus bet results may be based on the player's hand against the pay table (in other words, it may be a single bet that is independent of the dealer's hand(s)). The player's bet selections may be stored in the table data structure 222.N as well. The ante, side bet, and pair-plus bet rules will be described in more detail below with respect to FIGS. 5, 8, and 10-13.

FIG. 5 illustrates a UI which may include an “Ante” field 502, a “6 Card Bonus” field 516, and corresponding (+/−) controls to increase or decrease his/her bet per hand (Ante or 6 Card Bonus). In this example, the user may select to bet $10 per hand ($5 Ante bet+$5 6 Card Bonus bet=$10). The bet per all hands may be displayed in the “bets per all hands” field 506. In this example, the “bet per all hand” may be $120 ($10×12 hands). The user may also select a “pair plus” bet (in this case, $100) in a similar fashion by entering a bet in the “pair plus” field 508. The total bet may be displayed in a “total bet” field 510. In this example, the “total bet” may be $220 ($120 bet per all hands+$100 pair plus bet). A “balance” field 512, which may indicate a player's current balance, may be adjusted according to the “total bet” value. In this example, the player's balance may decrease from $10,000 (in FIG. 4) to $9780 (in FIG. 5) based on his/her bet values. The player's balance data stored in a corresponding player data structure, say 221.N, may be updated accordingly. The UI manager 216 may activate a “deal” button 514 after the player is done entering his/her bet values.

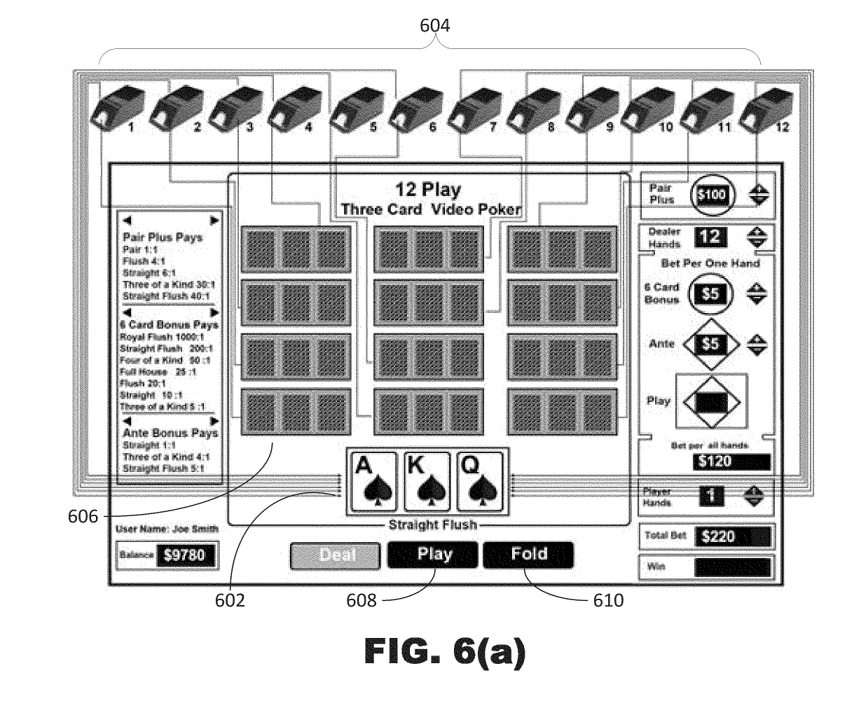

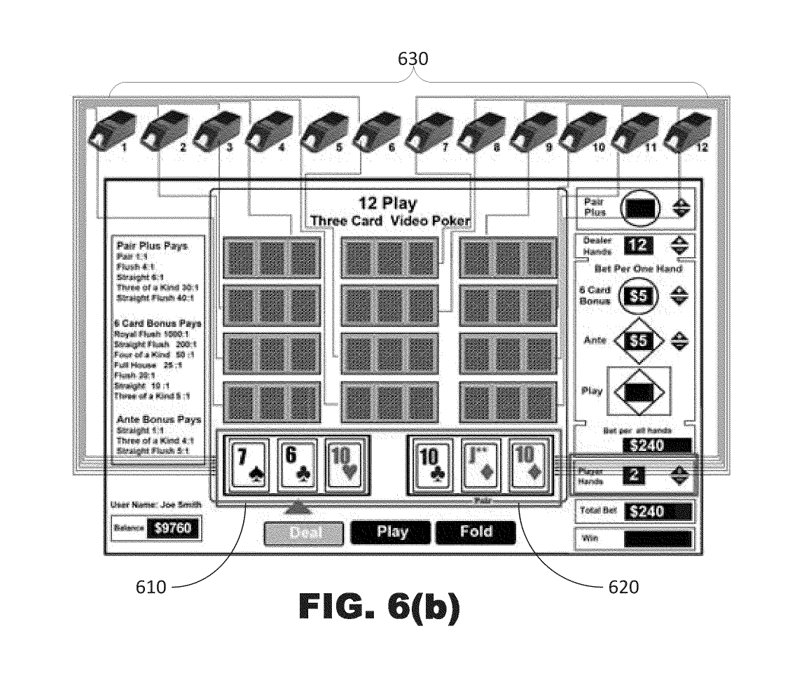

At step 308, after the player clicks on the “deal button” 514, the player's cards may be dealt by the UI manager 216 and the dealer simulator 215. After the players cards are dealt, the controls of the UI may be temporarily disabled (step 309). FIG. 6(a) is an example of a UI of a single-hand game according to an embodiment of the present invention. The player may be dealt a hand 602 of three cards (facing up). FIG. 6(b) is an example of a UI of a multi-hand game according to an embodiment of the present invention. The player may be dealt a first hand 610 and a second hand 620 of three cards (facing up). The arrow below the first hand 610 may indicate that the first hand 610 is active for a “Play” or “Fold” action. Moreover, a user may also place different bet values for each hand when it is active.

At step 310, the player's cards may be removed from each corresponding virtual shoe that may contain a single deck of fifty-two cards. The virtual shoe data corresponding to each virtual shoe stored at the table data structure 222.N may be updated accordingly. In FIG. 6(a) for example (i.e., the single-hand embodiment), the same three cards of the player's single hand may be removed from each one of the twelve virtual shoes 604 (the virtual shoes may not be displayed on the UI) involved in the round of play. There may be twelve virtual shoes 604 because the player chose twelve dealer hands to play against. In FIG. 6(b) for example (i.e., the multi-hand embodiment), the same six cards (three in the player's first hand 610 and three in the player's second hand 620) may be removed from each of the twelve virtual shoes 630 involved in the round of play. If there are multiple players (see FIG. 4(c) above), the cards in each of the players' hands may be removed from the virtual shoes. As noted above, each players' cards may be shown face up or face down until a fold/play action or the timer runs out based on whether the game is set to the “Public View” or “Private View” option.

At step 311, the dealer's cards for each dealer hand may be dealt from each corresponding shoe face down by the UI manager 216 and the dealer simulator 215. In FIG. 6(a) for example, the dealer is dealt twelve hands 606 (facing down), each dealt from one of the twelve virtual shoes 604. In other words, each shoe is assigned to one dealer hand. Each shoe may include one standard fifty-two card deck. At step 312, the player may choose to either fold or play. In FIG. 6(a) for example, once the dealer's hands 606 are dealt, a “play” button 608 and a “fold” button 610 may be activated by the UI manager 216. The player may determine whether to fold or play based on his/her hand 602 (in this case, a straight flush).

If the player decides to fold, the player may lose his/her ante bet and pair plus bet (step 314) and his/her balance may be adjusted accordingly at step 318. The player's 6 Card Bonus wager, however, may not be forfeited if the player decides to fold. If the player did include a 6 Card Bonus bet (or another side-bet), the player's side-bet may not be forfeited (step 313) and the game-play may proceed to step 316.

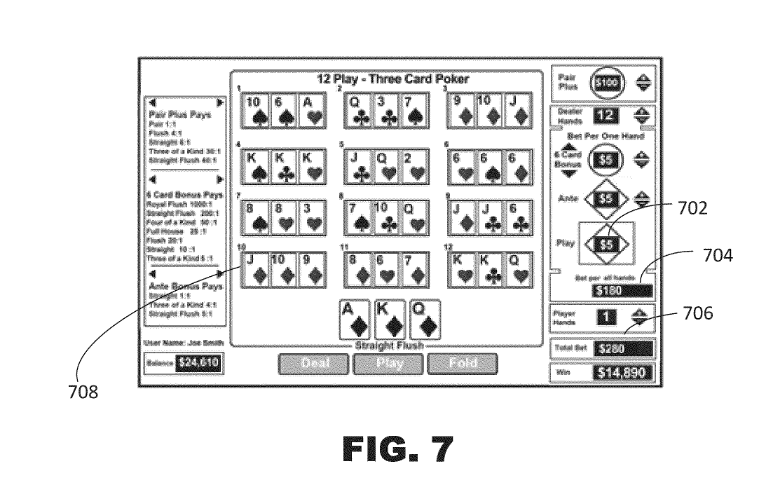

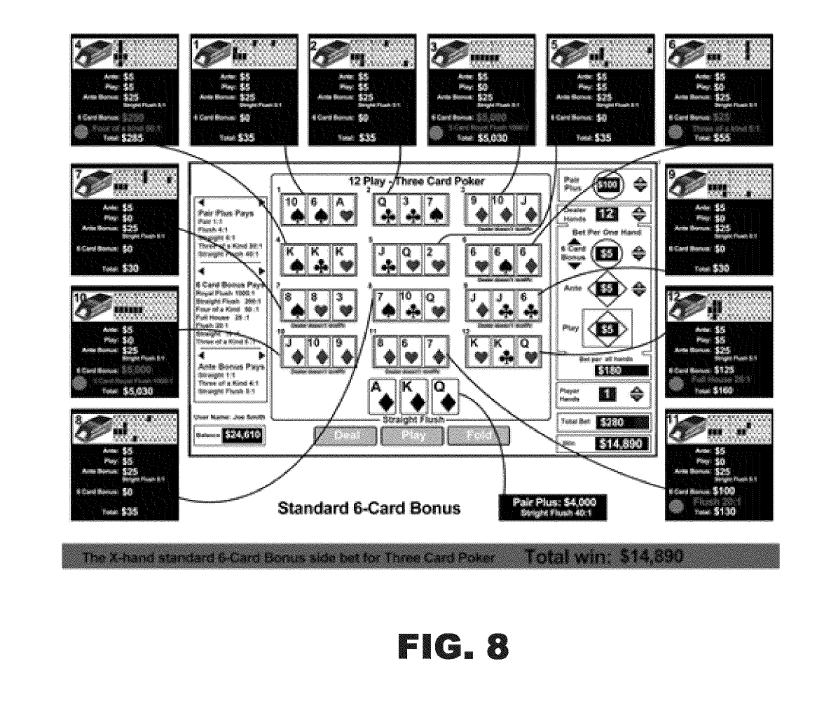

At step 315, if the player decides to play, the player may make an additional bet. The additional bet amount may be stored in the table data structure 222.N accordingly. In FIG. 7 for example, the UI may include a “play” field 702. The player may enter an additional “play” bet in the field if he/she desires. In this example, because the player has a solid hand (straight flush), he/she may decide to place a $5 “play” bet for each hand. The “bets per all hands” field 704 may increase to $180 because the player is now betting $15 on each hand ((($5 Ante bet+$5 Play bet)+$5 6 Card Bonus bet)×12 hands). The “total bet” field 706 also may be updated to $280 ($180 bet per all hands+$100 pair plus bet). The payout rules for the ante, play, and side bonus bets are described in detail below with reference to FIGS. 8 and 10-13.

At step 316, once the player makes an additional “Play” bet or the player decides to fold (at step 312), the dealer's hands may be shown by the UI manager 216 and the dealer simulator 215. In FIG. 7 for example, each of the dealer's twelve hands 708 may be displayed.

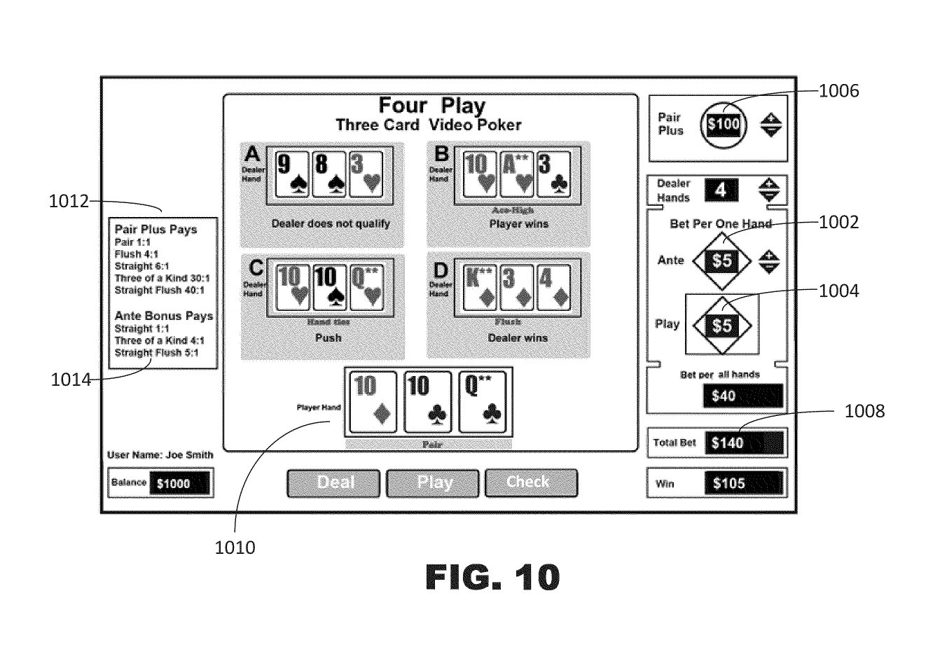

At step 317, the player's hand(s) is compared to the dealer's hands and to the pay tables (for the side-bets; this will be described in further detail below with respect to FIGS. 10-13) by the gameplay engine 214. The gameplay engine 214 may reference the gameplay rules data structure 224 to determine which hand is better in each instance or whether the player wins any side-bets in each instance. At step 318, the player's payout may be determined by the gameplay engine 214 and his/her balance may be adjusted accordingly in the corresponding player data structure 221.N.

FIG. 8 is a detailed diagram illustrating how pay-outs may be determined for each dealer hand 1-12 in a twelve hand standard “6 Card Bonus Side Bet Three Card Poker” game. The text boxes and shoes shown in FIG. 8(a) may not be displayed in the actual poker game UI, but are shown for explanatory purposes. Regarding dealer hand 2 for example, the player may win a $5 ante bet and a $5 play bet because his hand (straight flush) may be better than dealer hand (queen high). Moreover, the player may win a $25 ante plus bonus because he has a straight flush and there may be a 5:1 ante bonus payout for a straight flush (according to the ante bonus payout table on the left hand side of FIG. 8). The player may not win a 6 Card Bonus payout because no combination of the player's hand and the dealer's second hand creates any of the hands shown in the 6 Card Bonus payout table on the left hand side of FIG. 8. In this case, the player may win a total of $14,890 for all hands. The player's balance may be adjusted accordingly in the corresponding player data structure 221.N. The details of how payouts are determined will be described in further detail below with respect to FIGS. 10-13.

At step 319, the controls (the deal button, play button, fold button, betting fields, number of hands field, number of players field, etc.) may be enabled and at step 320 the player may decide whether or not to play again. If he/she decides to play again, the process begins at step 301. If the player decides to stop playing, the game ends (and the table is closed) at step 321. In FIG. 8 for example, the “Deal” button may be activated by the UI manager 216. If the player desires to play another round of multi-hand poker, the player may click on the “Deal” button and the process may start over at step 301 above. If the player does not want to play again, he/she may exit the table.

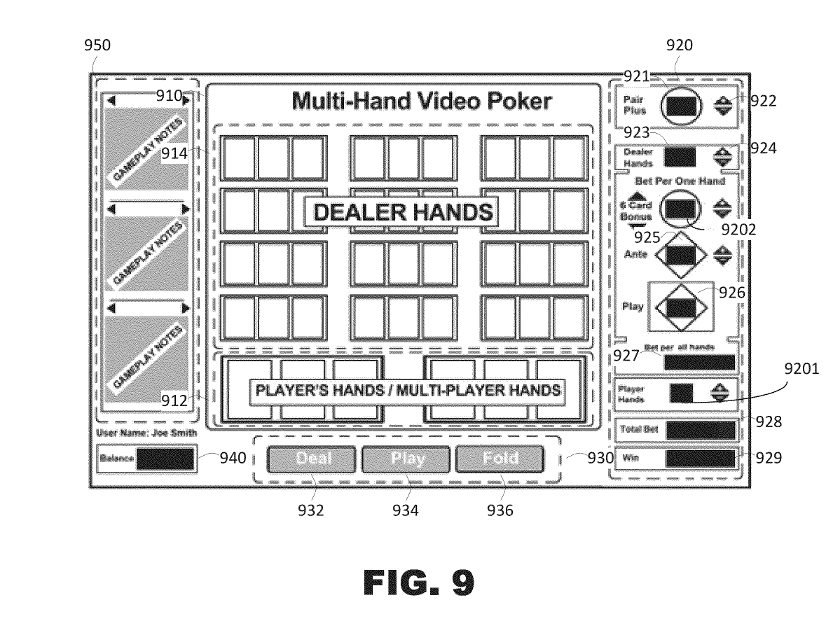

FIG. 9 illustrates an exemplary user interface for the system according to an embodiment of the present invention. The user interface 900 may include the following regions (or areas): a table region 910, a bet management region 920, a control region 930, a subscriber information region 940, and a notes region 950.

The table region 910 may display a player's hand(s)/multi-player hands 912 and dealer hand(s) 914. As shown in FIG. 9, the player's hand(s) 912 is displayed below each of the dealer's twelve hands 914. However, the positioning of the hands 912 and 914 may be in a different configuration (e.g., side to side). Moreover, the player may be able to play one or more hands at the same time (as shown in FIG. 4(b) above) and/or against other users (as shown in FIG. 4(c) above). For example, a user may choose to play two hands of three-card poker against twelve dealer hands and also against three other players (“multi-hand, multi-player” video poker). A player may also have the option to play four or five card poker against the dealer and/or other users.

The table region 910 may also display the type of hand for the user hand 912 and each of the dealer hand(s) 914. For example, if the player has a straight flush, a text box “Straight Flush” may be displayed below the user's hand. The same types of text boxes may be displayed under the dealer hand(s) 914. The table region 910 may also display “virtual shoes” (as described above) which correspond to each of the dealer's hands.

The bet management region 920 may display interactive user controls to manage betting aspects of a game. As shown in FIG. 9, the bet management region 920 may include a plurality of subcomponents. For example, the best management region 920 may include a pair plus bet field 921 and corresponding (+/−) controls 922, a dealer hands field 923 and corresponding (+/−) controls 924, an ante bet field 925 and corresponding (+/−) controls (not labeled), and a play bet field 926. A player may enter a pair plus bet by directly entering text into the field 921 or by increasing/decreasing the bet using controls 922. The text entry and controls for fields 923, 925, 926 may be similar to the pair plus bet field 921 above.

The bet management region 920 may also include a bets per all hand field 927, a total bet field 928, and a win field 929. The bets per all hand field 927 may display the total amount that the player may be betting for all hands. The value may be determined by the following equation: [Ante Bet+Play Bet+6 Card Bonus Bet]×# of Dealer Hands. The total bet field 928 may display the total bet that the player may be betting for the current round of poker. The value may be determined by the following equation: Bet Per All Hands+Pair Plus Bet. The win field 929 may display the amount a player has won for a given round of multi-hand video poker. The payout rules are described in more detail below with respect to FIGS. 10-13.

The bet management region 920 may also include a player hands field 9201 and corresponding (+/−) controls (not labeled) and a 6 Card Bonus bet field 9202 and corresponding (+/−) controls (not labeled). The text entry and controls for fields 9201 and 9202 may be similar to the pair plus bet field 921 above. The bet management region 920 may also have other components not shown in FIG. 9. For example, instead of (or in addition to) the (+/−) controls, the region 920 may also include buttons identifying default bet amounts (e.g., $10, $20, $50, $100, etc.). Users may click on these buttons instead of manually entering in bets.

The control region 930 may display other interactive user controls to manage game play. As shown in FIG. 9, the control region may include a deal button 932, a play button 934, and a fold button 936. The control region 930 may also include other buttons and/or controls (not shown in FIG. 9) such as a check button, a pause button (to stop gameplay while the user takes a break in multi-player mode), a call button, a pass button, etc.

The subscriber information region 940 may display information regarding the subscriber's profile. As shown in FIG. 9, the subscriber information region 940 may display a subscriber's (or player's) name and balance. The subscriber information region 940 may also display other information, such as the number of hands a user has played during the current poker session, the odds of winning for the user for a given hand, the odds of making certain hands, the user's win rate, the user's largest pot won, etc.

The notes region 950 may display gameplay notes or other system notification(s) that may be appropriate to display during gameplay. For example, the notes region 950 may display Pair Plus, Ante Bonus, 6 Card Bonus, and Prime Bonus payout rules and odds (see FIGS. 4-8 above and FIGS. 17(a)-(d) below). There also may be controls (such as buttons) located near the payout rules to allow players to decide which payout rules to display. The region 950 may further display the odds of winning form certain starting hands and odds of making certain hands. The region 950 may also display the number of tables the player currently has active, active players with the largest daily, weekly, or monthly winnings, advertisements, messages from other users currently on the site or from an administrator, a user identification (“ID”), a game ID, a round ID, game results history, financial transaction history, technical settings (sounds on/off, game speed, card size, animation on/off, etc.), help options, or personal settings to “stop the game” at a desired win/lost limit.

The UI displayed in FIG. 9 is only one example of a UI that may facilitate gameplay according to an embodiment of the present invention. Other UI designs and functionalities may be implemented to facilitate the gameplay of multi-hand video poker according to embodiments of the present invention.

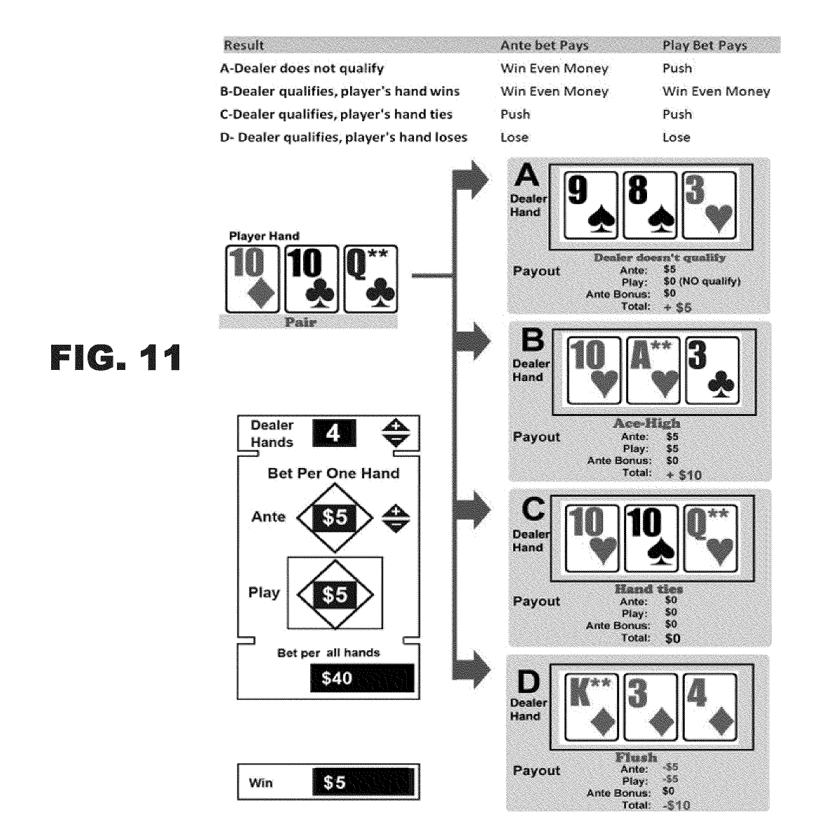

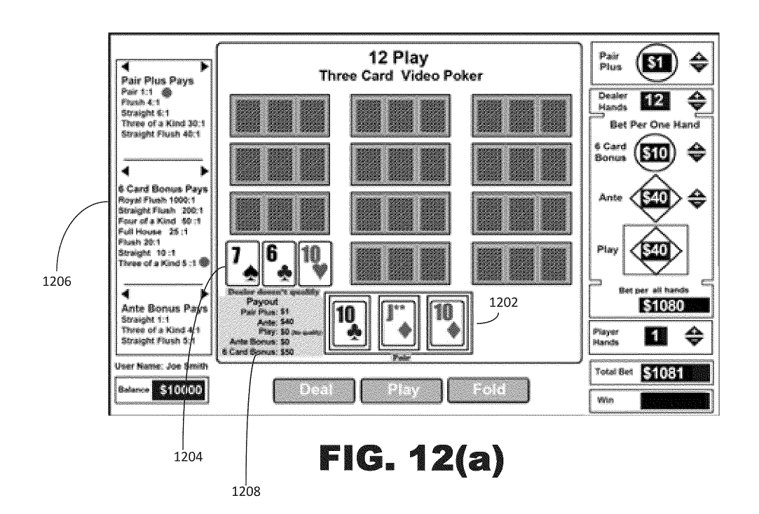

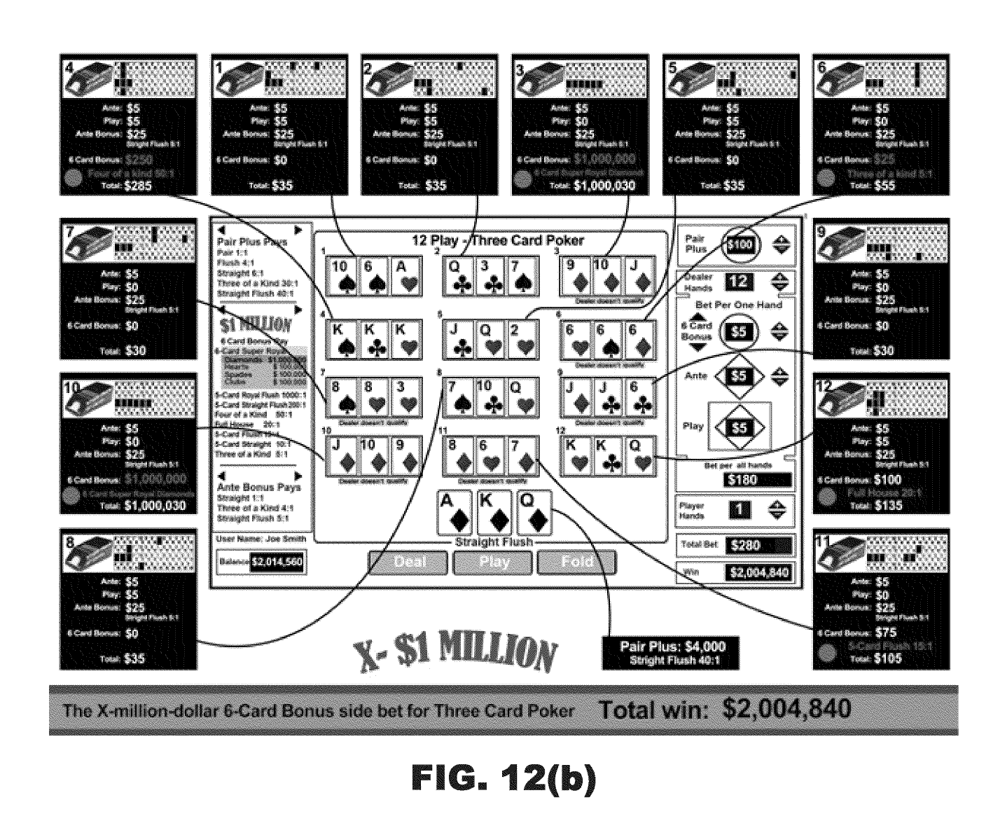

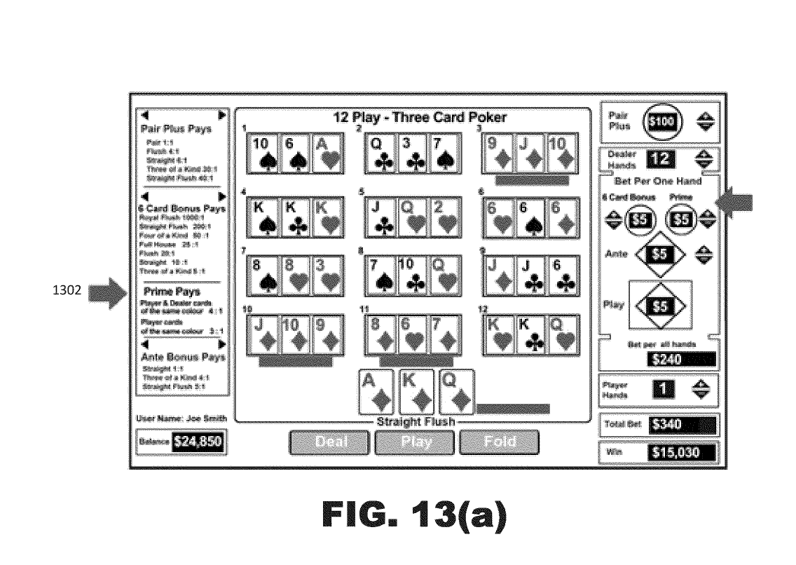

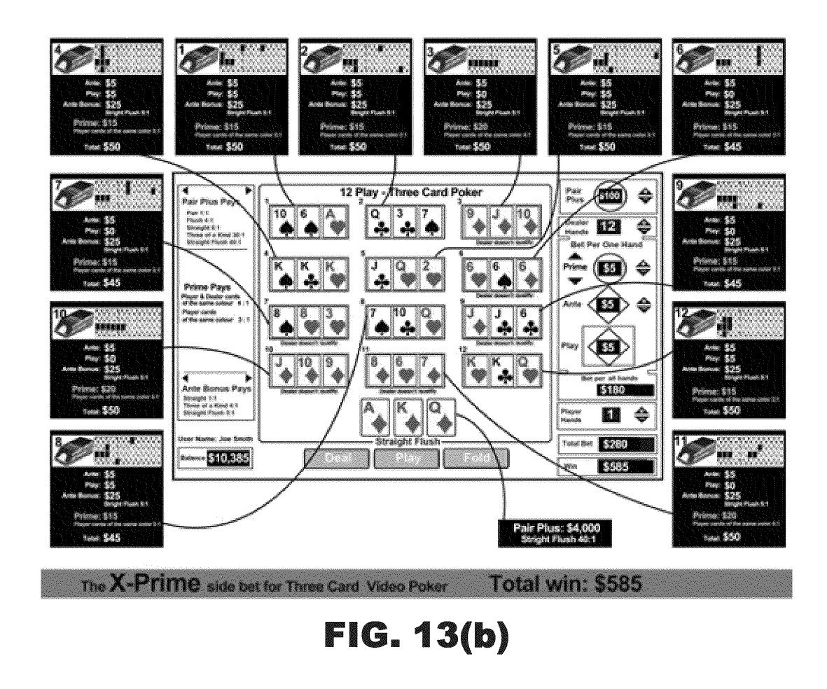

FIG. 10 is a screenshot of a UI for a multi-hand poker game according to an embodiment of the present invention. In the example shown in FIG. 10, the game may be a three-card multi poker game, where the player elects to play against four dealer hands. The screenshot in FIG. 10 may correspond to steps 308-311 described above with respect to FIG. 3 (i.e., the round is essentially over and the payouts now need to be calculated). In the example illustrated in FIG. 10, the player may have previously placed a $5 per hand ante bet 1002, a $5 per hand play bet 1004, and a $100 pair plus bet 1006. The total bet 1008 may therefore be $140 (($5 ante bet+$5 play bet)×4+$100). The dealer may have four hands, A, B, C, and D. Each of the dealer's hands may be compared to the player's hand 1010. Only the dealer hands that “qualify” (e.g., only dealer hands that have a queen high or better may qualify—this determination will be described further with respect to FIG. 11) may be eligible for a play bet payout. Moreover, the player's hand 1010 (a pair of 10s) may not qualify for the “Pair Plus” and “Ante Bonus” payouts according to the hands listed under the respective tables 1012 and 1014 (according to some embodiments, the UI may also include side-bet payout tables and rules, which will be in further detail below with respect to FIGS. 12 and 13).

FIG. 11 illustrates a comparison between the four dealer hands A, B, C, and D and the player's hand 1010 (in FIG. 9) and how payouts are determined for each hand. With respect to “Hand A,” the dealer's hand may not qualify because the dealer does not have at least a queen high. The player's hand (a pair of 10s) is better than the dealer's hand (9 high). Thus, the player may win an even bet (+$5) for his/her ante bet and may push for his/her play bet (because the dealer's hand does not qualify). With respect to “Hand B,” the dealer's hand may qualify in this example (i.e., because the dealer has an ace high). The player's hand is better than the dealer's hand. Thus, the player may win an even ante bet (+5) and an even play bet ($5) for a total of $10.

With respect to “Hand C,” the dealer's hand may qualify in this example (i.e., because the dealer has a queen high). The player's hand ties with the dealers hand (a pair of 10s). Thus, the player pushes on the ante and play bets for a total of $0. With respect to “Hand D,” the dealer's hand may qualify in this example (i.e., because the dealer has a king high). The player's hand is worse than the dealers hand (a flush). Thus, the player loses his $5 bet on both the ante and play bets. In the example shown in FIG. 11 above, the player may thus have a net winning of $5.

FIG. 12(a) is a diagram illustrating payout rules for a 6-Card Bonus side bet per hand scenario according to an embodiment of the present invention. A discussion of the payout rules for the ante and pair-plus bets will not be discussed in order to simplify the discussion of the payout rules for the 6 Card Bonus side bet in this instance. A 6 Card Bonus side bet may pay based on the best poker hand that is made out of the player's hand 1202 and one of the dealer's hands 1204 (six cards combined).

In this case, the player may win a $50 6 Card Bonus because he may have three of a kind (three tens) when his/her hand 1202 and one of the dealer's hands 1204 is combined. The payout odds may be displayed under the “6 Card Bonus Pays” text box 1206. Moreover, the UI may display a payout text box 1208 which may list a breakdown of the player's winnings per bet he/she made during a given round of game-play.

FIG. 12(b) is a more detailed diagram summarizing the payouts for a multi-hand video poker game, including 6 Card Bonus side bet calculations according to an embodiment of the present invention. The payout rules may be displayed to the left of the dealer's hands. For example, the text box on the upper left side of FIG. 12(b) explains how the payouts may be determined for dealer hand 4. The user may win a $5 ante bet and a $5 play bet for this hand because his hand may be better than dealer hand 4. The player may win a $25 ante bonus bet because he has a straight flush. For the 6 Card Bonus bet payout, a combination of the players hand and dealer hand 4 may be analyzed. In this case, the player may have four of a kind (four kings), which may have a 50:1 payout. Thus, the player will win $250 as his 6 Card Bonus bet payout for dealer hand 4. The payouts for the remaining dealer hands may be calculated in a similar fashion as shown in the corresponding text boxes in FIG. 12(b).

FIG. 13 is a diagram illustrating payout rules for a Prime side bet per hand scenario according to an embodiment of the present invention. A discussion of the payout rules for the ante, pair-plus, and 6 Card Bonus bets will not be discussed in order to simplify the discussion of the payout rules for the Prime side bet in this instance. If the player places a Prime wager of $5 per hand and receives three cards of the same color, the user may be paid according to the Prime payout rules 1302 for each hand he/she plays against the dealer (e.g., twelve hands in FIG. 13). For example, there may be a 3:1 payout if the player receives three cards of the same color. In this case, the player has three diamond suited cards, therefore he/she may win three times the Prime wager (i.e., $15) for each dealer hand. In other words, the player may win $15 for dealer hands 1, 2, 4, 5, 6, 7, 8, 9, and 12. Moreover, if both the player's and the dealer's cards for a given hand are all of the same suit, the player may receive an increased 4:1 payout. In other words, the player may win $20 for dealer hands 3, 10, and 11. If the player's hand does not meet any of these criteria, the Prime wager may be lost the and game may continue as normal.

FIG. 13(b) is a more detailed diagram summarizing the payouts for a multi-hand video poker game, including Prime side bet calculations according to an embodiment of the present invention. The payout rules may be displayed to the left of the dealer's hands. For example, the text box on the upper left side of FIG. 13(b) explains how the payouts may be determined for dealer hand 4. The user may win a $5 ante bet and a $5 play bet for this hand because his hand may be better than dealer hand 4. The player may win a $25 ante bonus bet because he/she has a straight flush. For the Prime bet payout, a combination of the players hand and dealer hand 4 may be analyzed. In this case, the player already has three cards of the same suit (three diamonds), which may have a 3:1 payout. However, because dealer hand 4 does not have three cards of the same suit as the player's hands (i.e., dealer hand 4 does not have any three diamond suited cards) the player does not get a 4:1 payout on his Prime side bet. Thus, the player will win $5 as his Prime bet payout for dealer hand 4. The payouts for the remaining dealer hands may be calculated in a similar fashion as shown in the corresponding text boxes in FIG. 13(b).

According to embodiments of the present invention, players may be able to make both 6 Card Bonus and Prime side bets in the same multi-hand video poker game. In such cases, both sets of payout rules may apply to each player and dealer hand combination as shown above. FIG. 13(a) illustrates an example of a UI in which a player may place both 6 Card Bonus and Prime side bets in the same game.

FIG. 14-16 illustrate gaming devices that that may implement the various multi-hand video poker games described above with respect to FIGS. 1-13 according to an embodiment of the present invention. The gaming devices may locally host video poker games (similar to video game terminal 130.N of FIG. 1) or may connect to a server, over a network, which hosts the video poker games. The gaming device 1400 of FIG. 14 may include a display 1401, a coin input 1402, a bill and/or coupon validator 1403, a card reader 1404, a credit (or balance) display unit 1405, and control buttons 1406.

The display 1401 may be a liquid crystal display (LCD) or the like. The display 1401 may display the UI of a video poker game according to an embodiment of the present invention. According to some embodiments of the present invention, the LCD may be a touchscreen.

The coin input 1402 may allow players to insert coins, chips, or other kinds of tokens to increase their poker playing balance. The bill and/or coupon validator 1403 may allow players to insert paper money (such as bills) and/or coupons to increase their poker playing balance. The card reader 1404 which may allow players to insert either a credit card or a card provided by a casino, for example, in order to increase their poker playing balance. The credit (or balance) display unit 1405 may be an LCD or the like. The credit display unit 1405 may display the player's current balance which may be adjusted accordingly during game-play as described above with respect to FIGS. 1-13.

Control buttons 1406 which may allow the user to interact with the UI of the video poker game as described above with respect to FIGS. 1-13. The game controls 1406 may include an ante bet (+/−) button, a pair plus (+/−) button, a 6 Card Bonus bet (+/−) button, a deal button, a fold button, a cash out button, etc. Optionally, the buttons 1406 may be implemented on a touchscreen version of the display 1401 or a separate display.

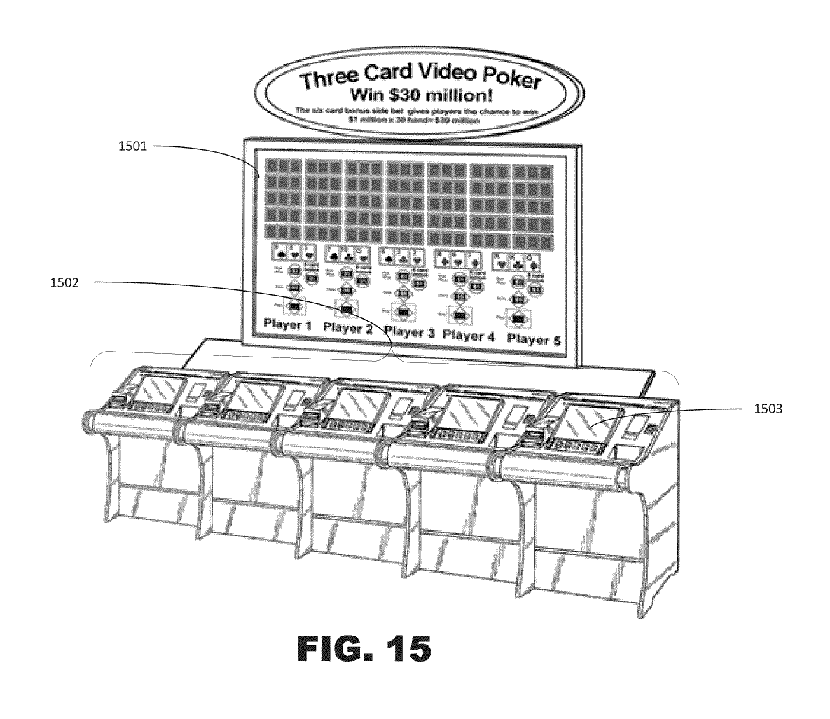

FIG. 15 illustrates a set of connected gaming devices 1502 (each may be similar to gaming device 1400 of FIG. 14), which may facilitate live, multi-player and multi-hand video poker games in a casino according to an embodiment of the present invention. Each gaming device in the set of devices 1502 may have its own display 1503 (similar to display 1401 in FIG. 14) to display the UI of the video poker games described above with respect to FIGS. 1-13. Each display 1503 may include a privacy screen protector to prevent other players from viewing the cards on the display. Moreover, there may be a community display 1501 which may display certain aspects of the multi-hand video poker game for all players (and spectators) to see. For example, the community display 1501 may display the dealer's hands, information about the active players, the time, advertisements, etc.

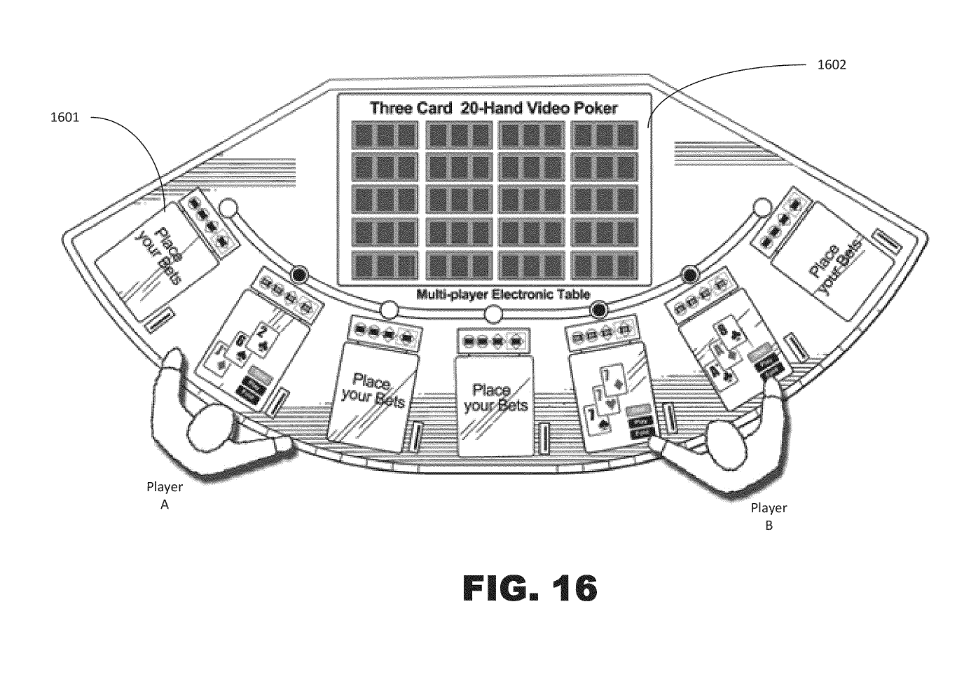

FIG. 16 illustrates an embodiment of an electronic gaming table device 1600 that may implement the various multi-hand video poker games described above with respect to FIGS. 1-13 according to an embodiment of the present invention. The gaming table device 1600 may allow a multiple players to play multi-hand video poker in a casino, for example. The gaming table device 1600 may include individual video displays 1601 and a community display 1602.

Individual video displays 1601 may be LCDs or the like. The video displays 1601 may each correspond to one or more player hands of video poker. Moreover the displays 1601 may display the UI of a video poker according to an embodiment of the present invention. According to some embodiments of the present invention, the LCD may be a touchscreen. The video displays 1601 may also include privacy screen protectors to prevent other players from seeing cards on the video display 1601. The community display 1602 may be similar to the community display 1501 of FIG. 15. The community display 1602 may be an LCD or the like and may display various aspects of the multi-hand video poker games described above with respect to FIGS. 1-13. For example, the community display 1602 may display the dealer's hands, information about the active players, the time, advertisements, etc.

The electronic gaming table device 1600 may allow players to play games in traditional casino table game manner by using touch technology, virtual cards, gaming accessories and controls. For example a first player (“Player A”) may be playing a single hand of the video poker game against the dealer while a second player (“Player B”) may be playing two hands of video poker against the dealer. Each player may set up an individual number of hands to play against the dealer. For example, Player A may play against the dealer on only four hands (e.g., the top row of the dealer's 20 hands) while Player B may play against the dealer on all 20 hands available on the table.

FIGS. 17(a)-(d) are exemplary pay-out tables for the various types of bets described above with respect to FIGS. 1-13. FIG. 17(a) is an example payout table for pair plus bets according to an embodiment of the present invention. The administrator (or a user) may select which payout odds he/she desires. For example, the administrator may determine that the odds in table 5 are the most beneficial for his/her business model. If the payout odds for table 5 are used, a player may win 50 times his pair-plus bet if he/she has a straight flush.

FIG. 17(b) is an example of a payout table for ante bet bonus payouts according to an embodiment of the present invention. The administrator (or a user) may select which payout odds he/she desires. For example, the administrator may determine that the odds in table 1 are the most beneficial for his/her business. If the odds for table 1 are used, a user may win five times his ante bet if he/she has a straight flush.

FIG. 17(c) is an example of a payout table for 6 Card Bonus bet payouts according to an embodiment of the present invention. The administrator (or a user) may select which payout odds he/she desires. For example, the administrator may determine that the odds in table 1 are the most beneficial for his/her business. If the odds for table 1 are used, a user may win $1,000,000 if he/she has a 6-card super royal flush (in diamonds).

FIG. 17(d) is an example of a payout table for Prime bet payouts according to an embodiment of the present invention. In this example, if a combination of the player's hand and any of the dealer's hands result in six cards of the same suit, the player may win four times his Prime bet value. Moreover, if the player's hand includes three cards of the same suit, he/she will win three times his Prime bet value.

The gaming system described above is not limited to the three-card poker embodiments shown above. The gaming system may also host four or five-card poker games, for example. Players may play with real or “play for fun” money. Players may also play against other players in tournaments via multi-player network systems (described above) or on a bank of connected machines. In such embodiments, the cards dealt to the additional players may also be withdrawn from the respective “virtual shoes” as described above.

Moreover, some components in the embodiments described above may be combined with each other as another embodiment, or a component may be divided into several subcomponents, or any other known or available component may be added. Those skilled in the art will appreciate that these techniques may be implemented in other ways without departing from the spirit and substantive features of the invention. The present embodiments are therefore to be considered in all respects as illustrative and not restrictive.

We claim:

1. A server, comprising:
a processor and a memory device, the memory device to store programming instructions for execution by the processor and data structures representing virtual tables maintained by the server and users interacting with the virtual tables; wherein the server:
communicates with a client device to render a virtual table on the client device, the virtual table having a plurality of dealer hands and at least one user hand,
receives communication from the client device representing gameplay decisions of a user;
deals the dealer hands and the user hand(s) as part of gameplay;
based on a comparison of each user hand with each dealer hand, determines payouts for the user from the gameplay, and
modifies a user data structure based on the determined payout.

2. The server of claim 1, wherein the gameplay decisions include a selection of bet types and values, wherein the possible bet types comprise bets per hand and side bets.

3. The server of claim 1, wherein the gameplay decisions include a selection of a number of other users to play on the virtual table.

4. The server of claim 3, wherein the gameplay decisions include a selection of either a public setting or a private setting, wherein the user's hand(s) is initially shown to the other users in the public setting and is not initially shown to the other users in the private setting.

5. The server of claim 1, wherein the gameplay decisions include a decision to play or fold after the user's hand(s) is dealt.

6. The server of claim 1, wherein the gameplay decisions include a selection of a number of user hands and a number of dealer hands.

7. The server of claim 1, wherein the memory device further stores a data structure representing a plurality of virtual shoes, one for each dealer hand.

8. The server of claim 7, wherein each card in the user's hand(s) is removed from each of the virtual shoes prior to dealing the dealer's hands.

9. A client device, comprising:
a processor configured to communicate with a server system of a gaming system, the processor further configured to:
receive communication from the server system to display a virtual table on the client device, the virtual table having a plurality of dealer hands and at least one user hand,
send communication to the server system representing gameplay decisions of a user;
receive communication from the server system to modify the displayed virtual table based on the gameplay decisions;
in response to the communication from the server system to modify the displayed virtual table, display a simulation of cards dealt to the dealer and the user at the virtual table; and
receive communication from the server system representing a payout determination.

10. The client device of claim 9, wherein the gameplay decisions include a selection of bet types and values, wherein the possible bet types comprise bets per hand and side bets.

11. The client device of claim 9, wherein the gameplay decisions include a selection of a number of other users to play on the virtual table.

12. The client device of claim 11, wherein the gameplay decisions include a selection of either a public setting or a private setting, wherein the user's hand(s) is initially shown to the other users in the public setting and is not initially shown to the other users in the private setting.

13. The client device of claim 9, wherein the gameplay decisions include a decision to play or fold after the user's hand(s) is dealt.

14. The client device of claim 9, wherein the gameplay decisions include a selection of a number of user hands and a number of dealer hands.

15. A computer gaming system, comprising:
client device; and
a server comprising a processor and a memory device, the memory device to store programming instructions for execution by the processor and data structures representing virtual tables maintained by the server and users interacting with the virtual tables; wherein the server:
communicates with the client device to render a virtual table on the client device, the virtual table having a plurality of dealer hands and at least one user hand,
receives communication from the client device representing gameplay decisions of a user;
deals the dealer hands and the user hand(s) as part of gameplay; and
based on a comparison of each user hand with each dealer hand, determines payouts for the user from the gameplay, and
modifies a user data structure based on the determined payout.

16. The system of claim 15, wherein the gameplay decisions include a selection of bet types and values, wherein the possible bet types comprise bets per hand and side bets.

17. The system of claim 15, wherein the gameplay decisions include a selection of a number of other users to play on the virtual table.

18. The system of claim 17, wherein the gameplay decisions include a selection of either a public setting or a private setting, wherein the user's hand(s) is initially shown to the other users in the public setting and is not initially shown to the other users in the private setting.

19. The system of claim 15, wherein the gameplay decisions include a decision to play or fold after the user's hand(s) is dealt.

20. The system of claim 15, wherein the gameplay decisions include a selection of a number of user hands and a number of dealer hands.

21. The system of claim 15, wherein the memory device further stores a data structure representing a plurality of virtual shoes, one for each dealer hand.

22. The system of claim 21, wherein each card in the user's hand(s) is removed from each of the virtual shoes prior to dealing the dealer's hands.

23. A method for playing an electronic card game, comprising:
receiving communication from a gaming system to display a virtual table at a client device, the virtual table having a plurality of dealer hands and at least one user hand,
sending communication to the gaming system representing gameplay decisions of a user;
receiving communication from the gaming system to modify the displayed virtual table based on the gameplay decisions;
in response to the communication from gaming system to modify the displayed virtual table, displaying a simulation of cards dealt to the dealer and the user at the virtual table; and
receiving payout determinations from the gaming system based on a comparison of each user hand to each dealer hand.

24. The method of claim 23, wherein the gameplay decisions include a selection of bet types and values, wherein the possible bet types comprise bets per hand and side bets.

25. The method of claim 23, wherein the gameplay decisions include a selection of a number of other users to play on the virtual table.

26. The method of claim 25, wherein the gameplay decisions include a selection of either a public setting or a private setting, wherein the user's hand(s) is initially shown to the other users in the public setting and is not initially shown to the other users in the private setting.

27. The method of claim 23, wherein the gameplay decisions include a decision to play or fold after the user's hand(s) is dealt.

28. The method of claim 23, wherein the gameplay decisions include a selection of a number of user hands and a number of dealer hands.

29. A non-transitory computer readable storage medium including instructions that, when executed by a processor, preform a method for playing an electronic card game, comprising:
receiving communication from a gaming system to display a virtual table at a client device, the virtual table having a plurality of dealer hands and at least one user hand,
sending communication to the gaming system representing gameplay decisions of a user;
receiving communication from the gaming system to modify the displayed virtual table based on the gameplay decisions; and
in response to the communication from gaming system to modify the displayed virtual table, displaying a simulation of cards dealt to the dealer and the user at the virtual table.

30. The non-transitory computer readable storage medium of claim 29, wherein the gameplay decisions include a selection of bet types and values, wherein the possible bet types comprise bets per hand and side bets.

31. The non-transitory computer readable storage medium of claim 29, wherein the gameplay decisions include a selection of a number of other users to play on the virtual table.

32. The non-transitory computer readable storage medium of claim 31, wherein the gameplay decisions include a selection of either a public setting or a private setting, wherein the user's hand(s) is initially shown to the other users in the public setting and is not initially shown to the other users in the private setting.

33. The non-transitory computer readable storage medium of claim 29, wherein the gameplay decisions include a decision to play or fold after the user's hand(s) is dealt.

34. The non-transitory computer readable storage medium of claim 29, wherein the gameplay decisions include a selection of a number of user hands and a number of dealer hands.

35. A device, comprising:
a processor and memory device to store programming instruction for execution by the processor and a plurality of data structures representing a virtual table and a user interacting with the virtual table; wherein the processor is configured to:
display the virtual table, the virtual table having a plurality of dealer hands and at least one user hand,
receive and process data representing gameplay decisions;
deal the dealer hands and the user hand(s) as part of gameplay; and
based on a comparison of each user hand with each dealer hand, determine payouts for the user from the gameplay, and
modify a user data structure based on the determined payout.

36. A system, comprising:
a plurality of player terminals;
a memory device to store programming instructions and a plurality of data structures representing a plurality virtual tables and players; and
a processor configured to execute the programming instructions to:
display a virtual table on each of the player terminals, the virtual table having a plurality of dealer hands and at least one hand for each active player operating the player terminals,
receive data from the player terminals representing player gameplay decisions;
deal the dealer hands and the player hands as part of gameplay;
based on a comparison of each players' hand with each dealer hand, determine payouts for each of the players from the gameplay, and
modify the player data structures based on the determined payouts.

37. The system of claim 36, further comprising a community display device to display the dealer's hands.

38. The system of claim 36, wherein the data received from the player terminals represents a selection of bet types and values for each active player, wherein the possible bet types comprise bets per hand and side bets.

39. The system of claim 36, wherein the player terminals are separate devices.

40. The system of claim 36, wherein the player terminals are part of a common electronic poker table.

41. The system of claim 40, wherein each player terminal comprises a display device.

42. The system of claim 41, wherein each display device comprises a privacy screen protector.

43. The system of claim 41, wherein the each display device is a touchscreen device.

44. A device comprising:
a display device,
a memory device to store one or more programs, and
a processor configured to execute the one or more programs to display a graphical user interface on the display device, wherein the graphical user interface comprises:
a table region to display one or more user poker hands comprising a plurality of virtual cards and at least two dealer hands, each comprising a plurality of virtual cards;
a bet management region comprising a first set of interactive user controls to manage bets and a number of user and dealer hands; and
a control region comprising a second set of interactive user controls to manage gameplay.

45. The device of claim 44, wherein the graphical user interface further comprises a user information region to display information regarding a user's profile.

46. The device of claim 44, wherein the graphical user interface further comprises a timer indicating time remaining in a round of poker.

47. The device of claim 45, wherein the graphical user interface further comprises a notes region to display payout amounts.
